(19) United States
(12) Patent Application Publication
(10) Pub. No.: US 2005/0046058 A1
(43) Pub. Date: Mar. 3, 2005

(54) Method and apparatus for imprinting disk substrate and method of manufacturing disk-shaped recording medium

(76) Inventors: Takahiro Suwa, Tokyo (JP); Kazuhiro Hattori, Tokyo (JP); Minoru Fujita, Tokyo (JP)

Correspondence Address: KENYON & KENYON, 1500 K STREET, N.W., SUITE 700, WASHINGTON, DC, 20005, US

(21) Appl. No.: 10/921,871

(22) Filed: Aug. 20, 2004

(30) Foreign Application Priority Data
Aug. 28, 2003 (JP) P2003-305025
Mar. 17, 2004 (JP) P2004-75871

(51) Int. Cl. B05D 5/00; B29D 11/00

(52) U.S. Cl. 264/1.33; 427/256; 425/810

(57) ABSTRACT

In a disk substrate imprinting operation, a disk substrate formed with a shape transfer layer is mounted on a mount table, a position of the disk substrate on the mount table is adjusted in a state of being supported at a taper portion of a position adjusting member which is disposed to be movable vertically with respect to the disk substrate, a position of a stamper disposed so as to oppose to the disk substrate is preliminarily adjusted with respect to the position adjusted disk substrate is preliminarily adjusted, and in this state, a fine pattern is shaped to the shape transfer layer of the disk substrate by the stamper.

### BACKGROUND OF THE INVENTION

1. Field of The Invention

The present invention relates to a disk substrate imprinting method, a disk substrate imprinting apparatus and a method of manufacturing a disk-(or disc-) shaped recording medium, and more specifically, relates to an imprinting method of a disk-shaped information recording medium such as magnetic disk, optical disk, magneto-optical disk or like.

2. Relevant Art

In these days, many researches and developments for information recording medium such as magnetic disk, optical disk, magneto-optical disk or like have been executed in order to improve the areal recording density, which will be referred to herein later as recording density.

For example, with magnetic disk mediums, in order to improve the recording density, many considerations have been made to minimize magnetic particles, to reduce magnetic anisotropy dispersion of the magnetic particles and to improve magnetic anisotropy energy of the magnetic particles, and many studies and experiments have been carried out in terms of addition of many kinds of additives to conventional recording mediums, formation of laminated structure utilizing materials having different characteristic features, search of recording mediums using new materials, and so on. However, in consideration of such factors as, for example, limit of fine working to a magnetic head, widening of magnetic head recording distribution, fluctuation in coercive force distribution and the like, it is strongly required for such magnetic disk mediums to further improve the recording density in a track direction. In these considerations, a discrete track medium has been listed up as desirable candidate for a high density recording medium.

The discrete track medium is one in which a magnetic recording layer in the magnetic disk medium is physically separated in the track direction, and such discrete track medium is manufactured by a nano-imprint (imprinting) method in which a shape-transfer layer is formed to a disk substrate and the shape-transfer layer is shaped by means of stamper having a fine pattern. According to such nano-imprint method, a large area can be formed at once, and the thus shaped disk substrate is thereafter subjected to a dry-etching method such as reactive-ion-etching.

In the nano-imprint method mentioned above, in order to reduce amount of eccentric distance of the track of the magnetic recording layer with respect to the disk substrate, it is necessary to maximally reduce the amount of eccentric distance between the disk substrate and the stamper.

As means for reducing such eccentric distance, it is known, in an optical disk field using an injection molding technique, a position adjusting method in which a center pin having a structure capable of changing its outer dimension is penetrated through central holes of the stamper and disk substrate in a manner such that the outer dimension of the center pin is made small when the disk substrate is positioned above the stamper and, on the other hand, is made larger after the disk substrate has been positioned above the stamper, thus adjusting the positional relationship between the stamper and the disk substrate. Such method is for example disclosed in Japanese Patent Laid-open (KOKAI) Publication No. HEI 9-231619 (231619/1997).

However, in such conventional method of reducing the amount of eccentric distance, it is obliged for the center pin to have a complicated structure, and accordingly, there is a fear that the usable durability of the center pin may be deteriorated, and in addition, since in a usual nano-imprint method, the stamper is used more than several tens thousand of shot times, the complicated structure of the center pin may involve an increased numbers of maintenance, resulting in reduced yielding or productivity, thus being inconvenient and disadvantageous.

### SUMMARY OF THE INVENTION

The present invention has been therefore conceived to substantially eliminate defects or inconveniences encountered in the prior art mentioned above, and a first object of the invention is to provide a method of imprinting a disk substrate capable of achieving mass-production with improved high productivity.

A second object of the present invention is to provide a method of manufacturing a disk-shaped recording medium utilizing the disk substrate imprinting method mentioned above.

A third object of the present invention provide an apparatus for imprinting a disk substrate capable of achieving mass-production with improved high productivity.

The above and other objects can be achieved according to the present invention by providing, in one aspect, a method of imprinting a disk substrate comprising the steps of:
preparing a disk substrate formed with a shape transfer layer;
adjusting a position of the disk substrate in a state of supporting the disk substrate by a support portion formed to a position adjusting member which is disposed to be vertically movable with respect to the disk substrate;
preparing a stamper which is disposed in a state that a relative positional adjustment between the stamper and the position adjusted disk substrate is preliminarily made; and
shaping a pattern to the shape transfer layer of the disk substrate by using the stamper.

In this first aspect, the disk substrate can be adjusted in the same or substantially the same position by supporting the disk substrate by the position adjusting member which is movable with respect to the disk substrate. Accordingly, the amount of eccentric distance between the central position of the disk substrate and the central position of the pattern (fine pattern) shaped by the stamper can be reduced, and in addition, even such shaping operation is repeated, the durability of the position adjusting member cannot be so deteriorated.

In a preferred embodiment of this aspect, the following subject features may be further defined.

That is, the disk substrate has a center hole and the position adjusting member comprises a single taper pin having a taper portion and the taper pin contacts the center hole of the disk substrate at at least three points of the taper portion of the taper pin so as to support the disk substrate when the taper pin is fitted to the center hole of the disk substrate.

The position adjusting member may comprise at least two taper pins each having a taper portion and the taper pins contact the center hole of the disk substrate at the taper portions of the taper pins so as to support the disk substrate when the taper pins are fitted to the center hole of the disk substrate.

The position adjusting member may comprise at least three taper pins each having a taper portion, and the taper pins contact an outer peripheral surface of the disk substrate at taper portions of the taper pins so as to support the disk substrate.

The position adjusting member may comprise a support cylinder having an inner hollow structure of polygonal shape more than triangular shape or circular shape and the support cylinder contacts an outer peripheral surface of the disk substrate at at least three inner taper portions of the support cylinder so as to support the disk substrate.

According to the disk substrate supporting modes mentioned above, the central position of the disk substrate can be stably supported, and the position adjustment can be hence performed with high precision and reproducibility.

Furthermore, it may be desired that the relative positional adjustment between the disk substrate and the stamper includes:
a test imprinting step in which, after the disk substrate is supported at the taper portion of the position adjusting member and adjusted in the position thereof by the position adjusting member, the pattern is shaped to the shape transfer layer of the disk substrate by using the stamper; a position adjusting step in which an amount of eccentric distance of the shaped pattern is measured and the relative position between the disk substrate and the stamper is adjusted in accordance with the measured amount of eccentric distance; and a repeating step in which the test imprinting step and the position adjusting step are repeated till the measured amount of eccentric distance becomes less than a preliminarily set eccentric distance.

According to such preferred embodiment in this aspect, the relative positional adjustment between the disk substrate and the stamper is preliminarily performed through the test imprinting step and position adjusting step, so that the imprinting process after the adjustment can be easily and precisely performed between the disk substrate and the stamper.

Furthermore, in this aspect, it may be desired that the relative positional adjustment between the disk substrate and the stamper is performed by abutting the taper portion of the position adjusting member against a center hole or an outer peripheral portion of the stamper.

In this preferred embodiment, the position adjustment is performed by abutting the taper portion of the position adjusting member against the center hole of the stamper or outer peripheral portion thereof, so that the disk substrate and the stamper can be simultaneously adjusted by the same position adjusting member.

In a further embodiment, the relative positional adjustment between the disk substrate and the stamper may be performed by moving the disk substrate or the stamper in a direction perpendicular to the moving direction of the position adjusting member.

In this embodiment, the relative position between the disk substrate and the stamper can be easily adjusted.

In a second aspect of the present invention, there is also provided a method of manufacturing a disk-shaped recording medium characterized by comprising the disk substrate imprinting method of the above first aspect.

According to this second aspect, various kinds of disc-shaped recording medium such as-magnetic disk, optical disk, magneto-optical disk or like disk may be efficiently manufactured.

In a third aspect of the present invention, there is further provided an apparatus for imprinting a disk substrate comprising:
a mount table on which a disk substrate, to which a shape transfer layer is formed, is mounted;
a position adjusting member having a taper portion and disposed to be vertically movable with respect to the mount table, the disk substrate being adjusted in the position thereof by being supported by the taper portion of the position adjusting member; and
a stamper disposed so as to oppose to the disk substrate in a state that a relative position between the stamper and the position adjusted disk substrate is preliminarily adjusted, the stamper being used to shape a pattern to the shape transfer layer of the disk substrate.

According to this aspect, the disk substrate is supported and position-adjusted by the taper portion of the position adjusting member arranged to be vertically movable with respect to the mount table, the disk substrate can be shaped and manufactured precisely with mass productivity without performing complicated workings by the stamper which is preliminarily adjusted in its position with respect to the disk substrate.

In a preferred embodiment of this third aspect, as mentioned with respect to the imprinting method of the first aspect, the position adjusting member may comprise a single taper pin having a taper portion and the taper pin contacts a center hole of the disk substrate at at least three points of the taper portion of the taper pin so as to support the disk substrate when the taper pin is fitted to the center hole of the disk substrate.

The position adjusting member may comprise at least two taper pins each having a taper portion and the taper pins contact the center hole of the disk substrate at at least three points of the taper portions of the taper pins so as to support the disk substrate when the taper pins are fitted to the center hole of the disk substrate.

The position adjusting member may comprise at least three taper pins which are arranged along outer peripheral portion of the disk substrate at substantially equal interval and each of which has a taper portion, and the taper pins contact an outer peripheral surface of the disk substrate at taper portions of the taper pins so as to support the disk substrate.

The position adjusting member may comprise a support cylinder having an inner hollow structure of polygonal shape more than triangular shape or circular shape and the support cylinder contacts an outer peripheral surface of the disk substrate at at least three taper portions of the inner taper portions of the support cylinder so as to support the disk substrate.

The imprinting apparatus may further comprise a member for moving the position adjusting member vertically with respect to the mount table so as to abut the taper portion of the position adjusting member against the center hole or outer peripheral portion of the stamper.

Furthermore, either one of the mount table and the stamper may be moved in a direction perpendicular to the moving direction of the position adjusting member.

The nature and further characteristic features of the present invention will be made more clear from the following descriptions made with reference to the accompanying drawings.

### BRIEF DESCRIPTION OF THE DRAWINGS

In the accompanying drawings:

FIG. 1 includes FIGS. 1A to 1C, which are illustrations for explaining a disk substrate imprinting method according to the present invention;

FIG. 2 includes FIG. 2A to FIG. 2F showing upper side views and perspective views of taper pins as position adjustment members of first and second examples of the present invention;

FIG. 3 includes FIGS. 3A to FIG. 3D, in which FIGS. 3A and 3B are upper side views showing the uniform arrangement of three taper pins as position adjusting member of the second example and FIGS. 3C and 3D are upper side view and front view of a support cylinder as a position adjusting member of a third example;

FIG. 4 includes sectional views of FIGS. 4A to 4C showing taper portions of the position adjusting members of the examples of the present invention;

FIG. 5 includes sequential views showing steps S1 to S10 for explaining a method of imprinting the disk substrate according to a first embodiment of the present invention;

FIG. 6 includes sequential views showing steps of S21 to S24 for explaining a method of imprinting the disk substrate according to a second embodiment of the present invention;

FIG. 7 includes sequential views showing steps of S31 to S34 for explaining a method of imprinting the disk substrate according to a third embodiment of the present invention;

FIG. 8 includes sequential views showing steps of S41 to S52 for explaining a method of imprinting the disk substrate according to a fourth embodiment of the present invention;

FIG. 9 includes sequential views showing steps of S61 to S66 for explaining a method of imprinting the disk substrate according to a fifth embodiment of the present invention;

FIG. 10 includes sequential views showing steps of S71 to S76 for explaining a method of imprinting the disk substrate according to a sixth embodiment of the present invention;

FIG. 11 is an illustration showing an example of supporting a center hole of the disk substrate in the disk substrate imprint method of the present invention.

### DESCRIPTION OF THE PREFERRED EMBODIMENTS

The disk substrate imprinting method, the disk substrate imprinting apparatus and the disk-shaped recording medium manufacturing method according to the present invention will be described hereunder with reference to the preferred embodiments thereof described in the accompanying drawings.

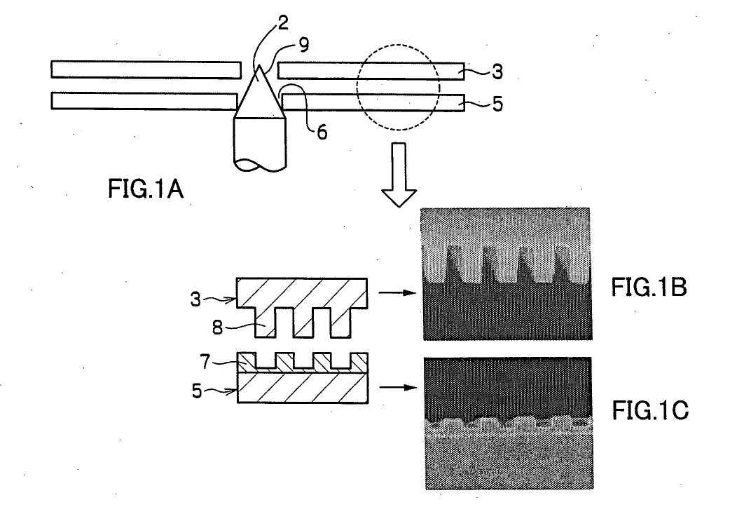

With reference to FIG. 1, FIG. 1A is an illustration explaining one mode of the disk substrate imprint method of the present invention, FIG. 1B is an enlarged photograph showing a shape of a stamper 3, and FIG. 1C is an enlarged photograph showing a fine pattern, on the disk substrate, shaped by the stamper 3.

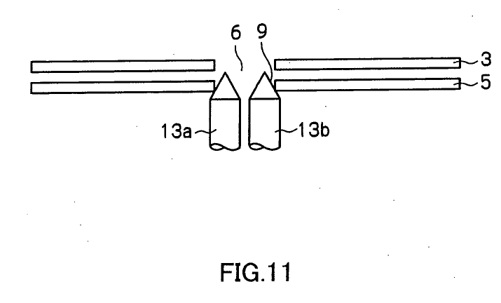

This example of FIG. 1 uses a single taper pin 2 as one preferred example of a position adjusting member for supporting a center hole of the disk substrate 5. Further, in the example of FIG. 11, two taper pins 13a and 13b are used for supporting the center hole of the disk substrate, which will be referred to hereinlater.

The disk substrate imprinting method of the present invention of FIG. 1 is concerned with a method of shaping a fine pattern 7, by using the stamper 3, on a shape transfer layer formed on the disk substrate 5, and this imprinting method includes a positioning step of positioning the disk substrate 5 by supporting it at a taper (tapered) portion 9 of a position adjusting member, i.e., taper pin 2, which is vertically movable with respect to a mount table 1, in the example of FIG. 1, and includes a shaping step of shaping the fine pattern 7 on the shape transfer layer of the disk substrate 5 by the stamper 3 which is preliminarily adjusted in its position relative to the position-adjusted disk substrate 5.

The imprinting method of the present invention involves two embodying modes as position adjusting method of adjusting relative position of the disk substrate and the stamper.

In the first embodying mode of the position adjusting method, the adjustment of the relative position between the disk substrate and the stamper comprises a test imprint step which is preliminarily carried out and a position adjusting step. According to such position adjusting method, the imprinting operation after the position adjustment can be achieved in a state that the disk substrate and the stamper have been easily and accurately aligned.

In the second embodying mode of the position adjusting method, on the other hand, the test imprinting step is not included, and the position adjustment is performed by abutting a taper (tapered) portion of a position adjusting member against a center hole of the stamper or an outer peripheral portion thereof. According to this method, the positions of both the disk substrate and stamper can be adjusted simultaneously by using the same position adjusting member.

Furthermore, a disk substrate imprinting apparatus of another embodiment of the present invention is an apparatus for realizing the embodiment of the imprinting method of the present invention mentioned above.

The disk substrate imprinting apparatus includes a mount table on which the disk substrate 5 is placed, a position adjusting member disposed on this mount table to be vertically movable with respect to the mount table 1 and a stamper 3 disposed so as to oppose to the disk substrate 5 in a state that the positional relationship between this stamper 3 and the disk substrate 5 is preliminarily adjusted.

In such imprinting apparatus, the position adjusting member is provided with a taper (tapered) portion 9 by which the disk substrate 5 is supported so as to adjust the position of the disk substrate 5 on the mount table. The stamper 3 is a member for shaping a fine pattern 7 on a shape transfer layer formed on the disk substrate 5. The imprinting apparatus further comprises a position adjusting device or means for moving one of the mount table and the stamper in a direction perpendicular to the moving direction of the position adjusting member.

The disk substrate, the stamper for shaping the fine pattern to the disk substrate and the position adjusting member supporting the disk substrate will be first explained hereunder.

The disk substrate for the imprinting method of the present invention has a disc shape and a shape transfer layer is formed on its surface. There will be listed up, as one example of such disk substrate, a substrate worked to a disk-shaped recording (packing) medium such as magnetic disk substrate, optical disk substrate, magneto-optical disk substrate and the like substrate.

Moreover, this disk substrate may be is applied to a case of obtaining an optical disk of which fine protrusions and recesses include data information or a case of obtaining an optical recording medium having information recording layer, such as magneto-optical recording layer or phase change recording layer causing phase change in response to light irradiation, of which fine protrusions and recesses are pre-grooves or pits for tracking or address.

Especially, the imprinting method according to the present invention will be preferably applicable to the manufacture of the discrete track medium. The discrete track medium is a magnetic disk medium in which a magnetic recording layer is physically separated in the track direction and highly promised as a high density recording medium. Accordingly, by applying the present invention to the manufacture of the discrete track medium, the discrete track medium, having reduced in its amount of eccentric distance, can be manufactured with high productivity.

Such disk substrate as mentioned above is mounted on the mount table and positionally aligned with high reproducibility by the position adjusting member disposed on the mount table.

The shape transfer layer, which is to be formed on the disk substrate, is formed of a material suitably according to the recording system or recording way. For example, in a magnetic disk substrate, a shape transfer layer (having a thickness of 70 nm, for example) may be formed, in form of film or layer, by forming a negative-type resist (for example, NEB22A2, manufactured by SUMITOMO KAGAKU KOGYO KABUSHIKI KAISHA), through a spin-coat method or like, above a glass substrate which is worked so as to have an outer diameter of 2.5 inches and an inner diameter of 20 mm, for example.

The stamper is formed with the fine shaping pattern for forming the discrete track on the shape transfer layer formed on the disk substrate. As one example of such stamper, there will be provided a circular stamper made of Ni and having a diameter of 2.5 inches and having a line of 135 nm, a space of 165 nm and a pitch of 300 nm. Such stamper is disposed so as to oppose to the disk substrate on the mount table.

The position adjusting member is provided with a taper portion to be vertically movable with respect to the mount table on which the disk substrate is disposed. This taper portion is formed to the position adjusting member so as to support the center hole of the disk substrate or outer peripheral portion thereof. The position adjusting member according to the present invention can support the disk substrate in three examples, which will be represented by FIGS. 1 to 3.

The first supporting example is represented by FIG. 1, in which a single taper pin 2 supporting the center hole 6 of the disk substrate 5 is utilized as the position adjusting member. In this example, it is desired for the taper pin 2 to have a shape such that the taper portion 9 thereof contacts the center hole 6 of the disk substrate 5 at at least three portions or points of the tapered surface of the taper pin 2 to achieve the accurate position adjustment or alignment of the disk substrate 5. It is especially desired that the taper pin 2 contacts the center hole 6 of the disk substrate 5 at three points of the tapered surface of the taper pin 2.

In this first example of arrangement, two or more than two taper pins 2 may be used as position adjusting member to support the center hole 6 of the disk substrate 5. For instance, FIG. 11 shows an example of using two taper pins 13a and 13b supporting the center hole 6 of the disk substrate 5. In the example, in which the center hole 6 of the disk substrate 5 is supported by two or more than two taper pins, it is also desired that the taper pins contact the center hole of the disk substrate at at least three portions or points of the tapered surfaces of the taper pins, and more especially, it is further desired that the taper pins contact the center hole of the disk substrate at three points of the tapered surfaces of the taper pins. Further, in the viewpoint of simple or compact structure, it may be desired to use a single taper pin such as in the example of FIG. 1.

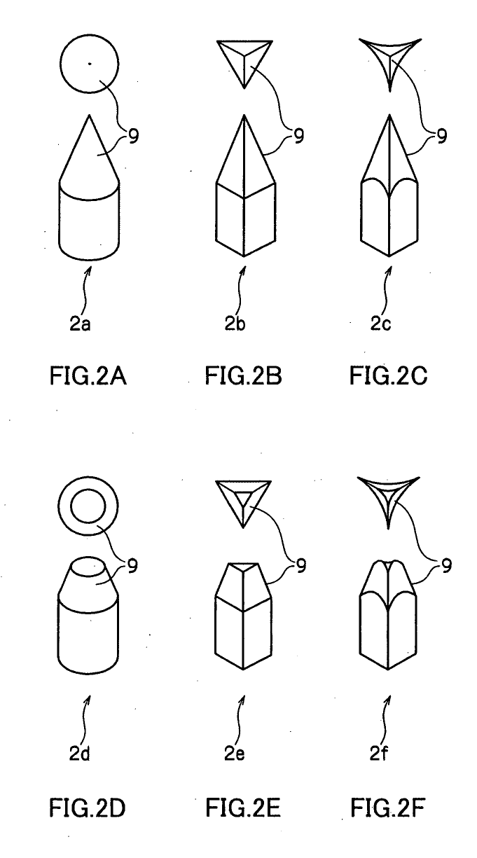

The taper pin 2 has various shapes of the taper portion 9 such as shown in FIG. 2, which will be described hereinlater.

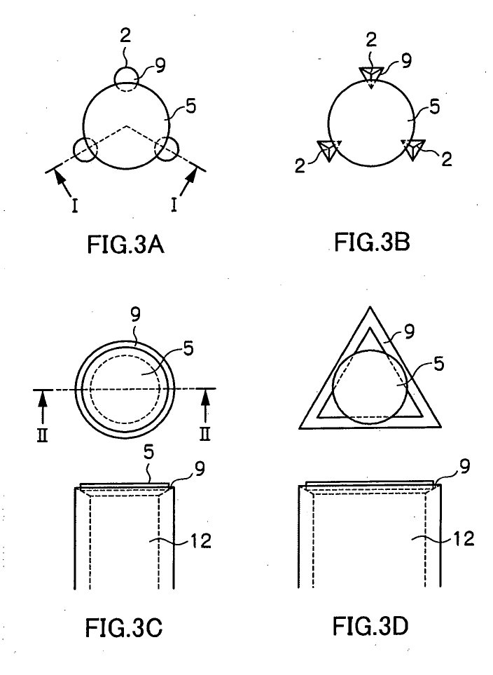

In the second example of arrangement as shown in FIGS. 3A and 3B, at least three taper pins 2 (three taper pins 2 in the illustration of FIG. 3) are arranged, as the position adjusting member, with substantially equal interval along the circumferential direction of the disk substrate 5. In this example of arrangement, it is desired that the taper portions 9 of the respective taper pins 2 contact the outer peripheral portions of the disk substrate 5, and by arranging the taper pins 2 in the described manner, the positional adjustment of the disk substrate 5 can be exactly performed. More specifically, it is further desired that the taper portions 9 of the three taper pins 2 contact the outer peripheral portions of the disk substrate 5.

In the third example of arrangement as shown in FIGS. 3C and 3D, a hollow support cylinder (or cylindrical structure) 12 is utilized as the position adjusting member. The support cylinder 12 has an inner hollow structure having a polygonal or circular cross sectional shape, and in the case of polygonal shape, it is desired to have more than triangular shape. In this example of arrangement, it is desired that the taper portion 9 of the hollow cylinder 12 contacts the outer peripheral portion of the disk substrate 5 at at least three portions or points of its tapered surface, and by arranging the hollow cylinder 12 in the described manner, the positional adjustment of the disk substrate 5 can be exactly performed. More specifically, it is further desired that the taper portion 9 of the hollow cylinder 12 contacts the outer peripheral portions of the disk substrate 5 at three points thereof.

The taper pin or pins 2 of the first example shown in FIG. 1 has the taper portion 9 of the shape shown in FIGS. 2A to 2F, for example: conical shape, conical shape of triangular pyramid shape, square pyramid shape or pentagonal pyramid shape; trapezoidal shape formed by cutting off the tip end portion of the taper portion of these shapes; or star-shaped cross section of the taper portion 9 such as triangular star shape, square star shape or pentagonal star shape.

The most desirable shape of the taper portion 9 of the single taper pin 2 is a shape which contacts, at three points of the tapered surface thereof, the center hole 6 of the disk substrate 5 such as represented by the triangular pyramid shape of FIG. 2B, the triangular star shape of FIG. 2C, and the trapezoidal shape of FIGS. 2E and 2F formed by cutting off the tip end portions of the shapes of FIGS. 2B and 2C. FIG. 2A shows an example of a circular conical shape of the taper pin 2.

Further, the tapered surface of the taper portion 9 of the taper pin 2 contacting the center hole 6 of the disk substrate 5 may have sharp surface or smooth curved surface, and such taper pin 2 may be utilized in the case that two or more than two taper pins 2 are utilized.

The taper pin 2 has a tapered angle, i.e., inclination from the center axis of the taper pin 2, of about 10 to 80 degrees, and the angle of 30 to 60 degrees is more preferable. In a case of the taper angle of less than the lower limit of the above angle, the taper pin 2 may be moved at a largely different lifting distance due to non-uniformity of the diameter of the center hole of the disk substrate. On the other hand, in a case of the taper angle of more than the upper limit of the above angle, a portion near the taper pin insertion hole of the mount table for the disk substrate may have a thin thickness and, as a result, at this portion, a sufficient strength may not be applied and insufficient pressing force may be applied at the time of imprinting. Furthermore, in a case where the taper pin contacts both the center holes of the disk substrate and stamper, the taper angle of the taper pin is adjusted so that the taper portion of the taper pin contact these two holes.

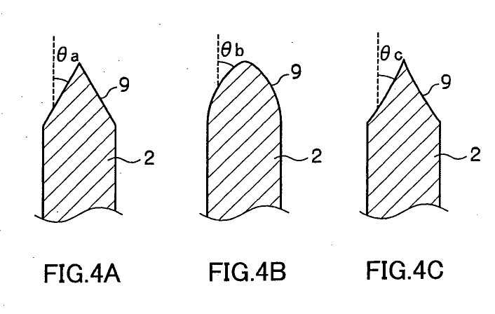

With the position adjusting members of the first to third examples of arrangements, although it is described that the taper portions generally have linear oblique surfaces, the present invention is not limited to such shape and the taper portions have many other shapes such as round surfaces or curved surfaces. For example, FIG. 4 shows examples of sectional views of the tapered surface of the taper portion of the position adjusting member, in which FIG. 4A shows an example of a taper portion having a linear oblique surface, FIG. 4B shows an example of a taper portion having a round oblique surface, and FIG. 4C shows an example of a taper portion having an inwardly curved oblique surface. Further, in these examples of the taper portion, it is at least desired that a taper portion to which the disk substrate contacts has a taper angle θ (shown in FIGS. 4A, 4B, 4C) in the range mentioned herein before.

Furthermore, although material or substance of the taper pin, that is, more in detail, material or substance at the portion of the taper pin which contacts the center hole of the disk substrate, is not specifically defined, SUS304 may be, for example, is provided. Each of these taper pins contacts the inner peripheral portion of the disk substrate at three points of the tapered surface thereof, so that the positional adjustment can be more surely achieved by such taper pin. On the other hand, in the case of two or more than two taper pins for supporting the center hole of the disk substrate, the number of the taper pins and the shape thereof will be selected so that the respective taper pins contact, at their one or two points of the tapered surfaces thereof, the inner peripheral portions of the disk substrate. According to such manner, the positional adjustment of the disk substrate by using two or more than two taper pins can be also surely achieved.

In the second example of arrangement, substantially the same taper pin as that mentioned above with respect to the first example will be utilized as three taper pins, for example, such as the taper pin of the shape of FIG. 2. Moreover, since each of the taper pins of this second example contacts, at one point of the tapered surface thereof, the outer peripheral portion of the disk substrate as shown in the example of FIG. 3A or 3B, a conical taper pin (FIG. 2A) or trapezoidal taper pin (FIG. 2D), formed by cutting off the top end portion of the conical taper pin, may be utilized in place of the taper pin of the first example which contacts the disk substrate at three points.

In this second example, it is also desired that the taper angle, which is an angle from the center axis of the taper pin, the shape of the tapered surface thereof and the material of the taper pin are substantially equal or identical to those of the first example. In this second example, since at least three taper pins contact the outer peripheral surface of the disk substrate, the positional adjustment of the disk substrate can be more precisely realized.

Next, the support cylinder or cylindrical structure 12 of the third example of arrangement has an inner hollow structure having polygonal inner cross sectional shape of more than triangular pyramid shape or circular inner cross sectional shape and having a tapered inner peripheral portion at its end portion. As such cylinder, the structure shown in FIG. 3 will be provided, in which FIG. 3C shows an example of circular inner hollow shape and FIG. 3D shows an example of inner triangular shape. Among of them, the triangular cylinder can support the outer peripheral portion of the disk substrate at three points, so that the positional adjustment of the disk substrate by the cylinder can be more preferably achieved.

In this third example, it is also desirable that the taper angle of the inner peripheral portion of the support cylinder, the shape of the tapered surface thereof and the material of the support cylinder taper pin are substantially equal or identical to those of the taper pin of the first example. In this third example, since at least three points of the tapered surface of the cylinder contact the outer peripheral surface of the disk substrate, the positional adjustment of the disk substrate can be more precisely achieved.

The disk substrate imprinting method according to the present invention will be described hereunder with reference to the preferred embodiments.

(First Embodiment)

The first embodiment of the disk substrate imprinting method of the present invention utilizing the first example of the position adjusting member mentioned above will be first described.

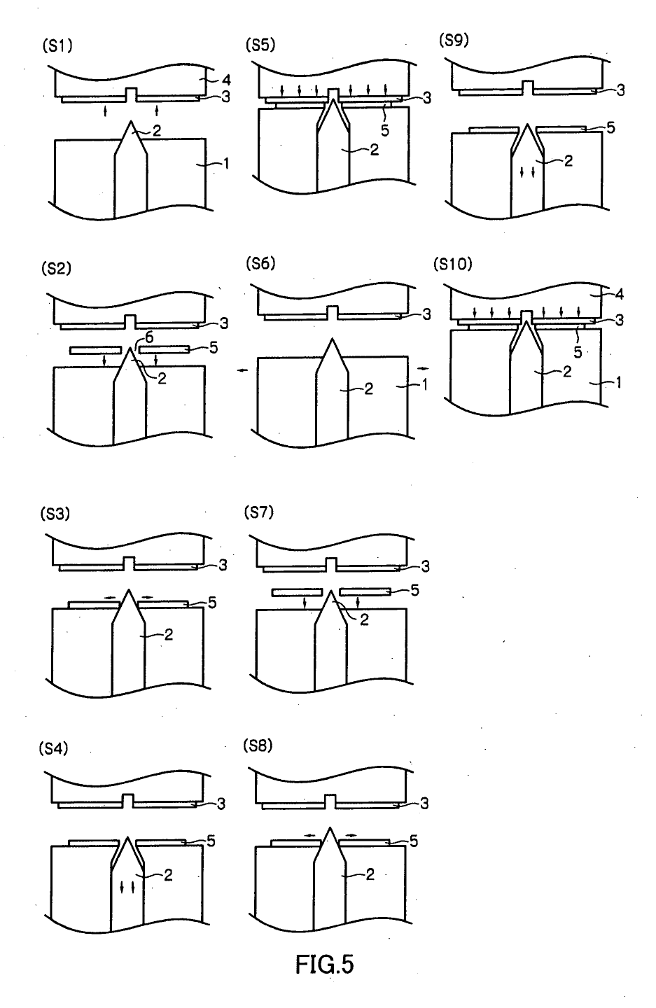

This first embodiment is concerned with the relative positional adjustment between the disk substrate and the stamper of the first embodying mode, the imprinting method of this first embodiment includes the steps of S1 to S10 represented by FIG. 5.

As mentioned above, the characteristic features of this first embodiment resides in the adoption of the position adjusting member of the first example and the first embodying mode of the adjusting method.

With reference to FIG. 5, an imprinting apparatus comprises a mount table 1 on which the disk substrate is mounted, a taper pin 2 disposed to be vertically movable in the illustrated state with respect to the mount table 1 and a stamper 3 disposed so as to oppose to the disk substrate on the mount table 1. As one typical example of such imprinting apparatus, an air-pressing type nano-imprinting apparatus may be provided.

In the first step S1 of the imprinting method of FIG. 5, the stamper 3 is mounted to a stamper mount table 4, the disk substrate 5 on which a shape transfer layer is formed is then mounted to the mount table 1 (step S2). In this step S2, the disk substrate 5 is mounted so that the center hole 6 thereof is supported by the taper portion of the taper pin 2 to thereby surely adjust the positional relationship therebetween (step S3).

Next, the taper pin 2 is lowered by, for example, about 5 mm (step S4), and this lowering distance (or speed) is determined so as not to abut against the stamper 3 which is thereafter lowered. The stamper 3 is then lowered to carry out a test imprinting operation at a pressure of 32 kgf/cm² (=3.1 MPa) and temperature of 140° C. as shown in the step S5. According to this test imprinting step, a fine pattern is shaped on the shape transfer layer of the disk substrate 5 as shown in FIG. 1C

Thereafter, stamper 3 is lifted up (moved upward) so as to separate the stamper 3 from the disk substrate 5, and the disk substrate 5 is then removed from the mount table 1. The amount of eccentric distance (which may be called merely eccentric distance hereinlater) between the central position of the disk substrate 5 and the central position of the shaped fine pattern in this step is measured by an optical microscope provided with a position measurement mechanism. According to the result of such eccentric distance measurement, the mount table 1 is moved in the direction perpendicular to the elevational direction, i.e., vertically moving direction, of the taper pin (i.e., X-Y axis direction), thus performing the positional adjustment (step S6).

The measurement of the eccentric distance of the disk substrate 5 is carried out by measuring the central position of the shaped fine pattern through the ten-point measurement of the most inner peripheral track of the shaped pattern transferred on the disk substrate, and then measuring the central position of the disk substrate through the ten-point measurement of the inner peripheral position of the center hole 6 of the disk substrate 5. The central position of the shaped fine pattern and the central position of the disk substrate are compared. In this comparison, the positional shifting therebetween is calculated as “(amount of) eccentric distance”. This calculation of the eccentric distance is performed by repeating several times the same measurement (for example, three times) to ensure the reproducibility, and the eccentric distance is expressed as its average value.

The test imprinting steps and the positional adjustment mentioned above will be performed by repeating the test imprinting step of the steps S2 to S6 several times till the measured or calculated eccentric distance becomes less than the preliminarily set allowable eccentric distance of the disk substrate. In such manner, the position of the mount table 1 is ensured. The preliminarily set amount of eccentric distance is different in the kind of the recording medium, and for example, the set values of the eccentric distance are different in the cases of the magnetic disk medium and the optical disk medium. Further, it is desirable that the test imprinting mentioned above is carried out with substantially the same conditions in terms of pressure, temperature and the like as those of an imprinting step which will be carried out after the relative positional adjustment in a viewpoint that deformation which may be caused in the imprinting step due to thermal expansion, stress or like does not make different.

According to such positional adjustment, the relative position between the stamper 3 and the disk substrate 5 is preliminarily adjusted. Then, the disk substrate 5 is set on the mount table 1 in step S7, and the disk substrate 5 is fixed thereto by means of the taper pin 2 so that the central portion of the disk substrate 5 accords with the tip end potion of the taper pin 2 (step S8). Thereafter, as in the step S4, the taper pin 2 is lowered by, for example, about 5 mm (step S9), and the stamper 3 is then lowered to carry out a nano-imprinting operation at a pressure of 32 kgf/cm² (=3.1 MPa) and temperature of 140° C. (step S10).

According to the above steps S1 to S10, the disk substrate to which the fine pattern is shaped was obtained. A plurality of imprinted disk substrates (for example, three disk substrates) were prepared and the eccentric distance thereof was measured, as in the test imprinting step mentioned above, by using an optical microscope provided with a position adjusting mechanism. The measurement of the eccentric distance of the disk substrate 5 was carried out by measuring the central position of the fine pattern shaped through the ten-point measurement of the most inner peripheral track of the shaped pattern transferred on the disk substrate, and then measuring the central position of the disk substrate through the ten-point measurement of the inner peripheral position of the center hole 6 of the disk substrate 5. The central position of the shaped fine pattern and the central position of the disk substrate were compared. In this comparison, the positional shifting therebetween is calculated as “eccentric distance”. This calculation of the eccentric distance was performed by repeating several times the same measurement (for example, three times) to ensure the reproducibility, and the eccentric distance was expressed as its average value.

The eccentric distance concerning the stamper 3 will be measured by substantially the same or identical as or to that for the disk substrate 5 mentioned above. That is, the central position of the fine pattern formed to the stamper and the central position of the stamper 3 are compared, and the length of the positional shifting therebetween is calculated as eccentric distance.

The following Table 1 represents one example of the eccentric distance as a result obtained, through experiment, with respect to a magnetic disk medium of 2.5-inch hard disk drive (HDD).

With reference to the Table 1, it is for example shown that, in the result of the first time test imprinting operation (1) using the stamper 3 having eccentric distance of 53.38 μm, the “eccentric distance” is 112.39 μm. According to this result, the mount table 1 is moved in the direction (X-Y axis direction) perpendicular to the moving direction of the taper pin 2 so that the central position of the pattern described to the stamper 3 accords with the central position of the taper pin 2 to thereby perform the position adjustment.

Then, the second test imprinting operation (2) was carried out, and in its result, the “eccentric distance” is 78.88 μm, and therefore, the positional adjustment was again carried out in the manner identical to the manner in the above test imprinting operation (1).

Next, the third test imprinting operation (3) was carried out, and in its result, the “eccentric distance” was 25.50 μm. This value is a value lower than an indicated value of allowance of 40 μm for the eccentric distance of the HDD. Accordingly, in this example, the “eccentric distance” was adjusted less than the allowable value in the third (tree times) test imprinting operations. Under such positional adjustment, the imprinting operation was conducted to the disk substrate by three times. As a result, the “eccentric distance” was 14.01 to 23.93 μm, which is less than the aimed indicated value of allowance of 40 μm.

TABLE 1

| | Eccentric Distance (μm) |
|---|---|
| Stamper Eccentric Distance | 53.38 |
| Eccentric Distance after | 112.39 |
| Test Imprinting (1) | |
| Eccentric Distance after | 78.88 |
| Test Imprinting (2) | |
| Eccentric Distance after | 25.50 |
| Test Imprinting (3) | |
| Eccentric Distance after | 14.01 |
| Imprinting (1) | |
| Eccentric Distance after | 22.51 |
| Imprinting (2) | |
| Eccentric Distance after | 23.93 |
| Imprinting (3) | |

As described hereinbefore, in the imprinting method according to the first embodiment of the present invention, after the securing the stamper to the position opposing to the disk substrate 5, the position of the disk substrate 5 is surely adjusted and arranged by using the taper pin 2. Thereafter, the shape transfer layer on the disk substrate is shaped by the stamper 3, and then, the eccentric distance of the thus obtained disk substrate is measured. These steps are repeated several times, and as a result of the measured amount of the eccentric distance, the central position of the fine pattern formed to the stamper 3 is controlled so as to accord with the central position of the taper pin 2. As a result, in the disk substrate exchanging time after this positional adjustment, the positional adjustment between the central position of the fine pattern formed to the stamper and the central position of the disk substrate can be performed within the allowable range only by mounting the disk substrate on the mount table so as to support the center hole of the disk substrate by the taper portion of the tapered surface of the taper pin, thus being convenient and advantageous.

(Second Embodiment)

The second embodiment of the disk substrate imprinting method of the present invention utilizing the second example of the position adjusting member mentioned above will be described.

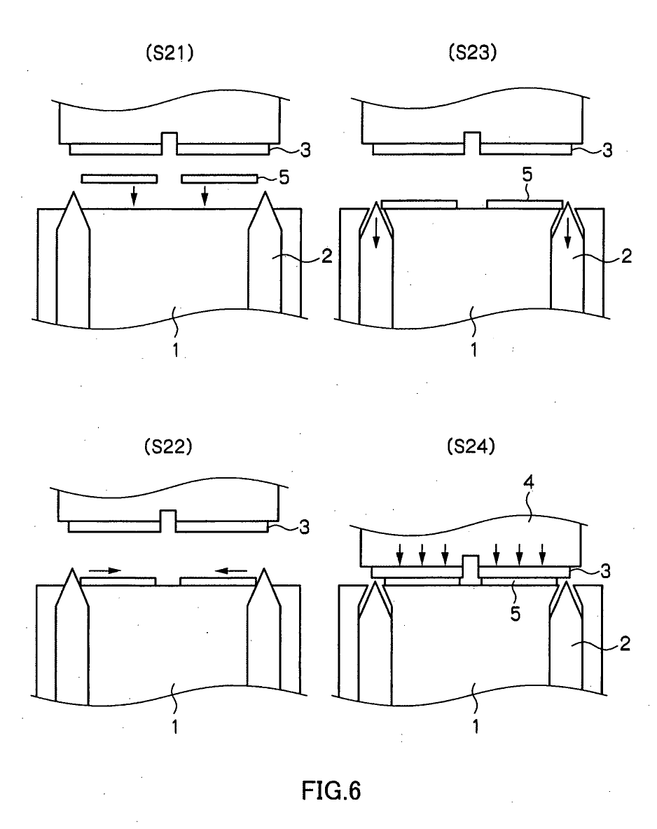

This second embodiment is concerned with the relative positional adjustment between the disk substrate and the stamper of the first embodying mode, the method of this second embodiment includes the steps of S21 to S24 represented by FIG. 6.

As mentioned above, the characteristic features of this second embodiment resides in the adoption of the position adjusting member of the second example and the first embodying mode of the adjusting method.

With reference to FIG. 6, the illustrated states of the steps S21 to S24 are shown as the sectional view taken along the line I-I of FIG. 3A and correspond respectively to the steps S7 to S10 of the first embodiment of FIG. 5. In the first step S21 of the imprinting method of this second embodiment, the disk substrate 5 is mounted on the mount table 1. In the next step S22, the central position of the disk substrate 5 is adjusted and then fixed by using three taper pins 2. The three taper pins 2 are then lowered (step S23), and the stamper 3 is thereafter lowered to thereby carry out the imprinting operation (step S24).

The imprinting steps of the second embodiment is substantially identical to those of the first embodiment mentioned above in their basic principal except that the three taper pins 2 are utilized. Accordingly, test imprinting operation and relative positional adjustment between the stamper and the disk substrate are substantially the same as those in the first embodiment. In addition, as will be mentioned hereinafter with reference to a fourth embodiment, the basic principal of the simultaneous positional adjustment, by the taper portion 9 of the taper pin, between the disk substrate 5 and the stamper 3 is also substantially identical to that in the imprinting steps of the first embodiment.

In the imprinting method of the second embodiment mentioned above, in the disk substrate exchanging time after this positional adjustment, the positional adjustment between the central position of the fine pattern formed to the stamper and the central position of the disk substrate can be performed within the allowable range only by mounting the disk substrate on the mount table so as to support the outer peripheral portion of the disk substrate by the taper portions of at least three taper pins, thus being convenient and advantageous. Further, although, in the illustration of FIG. 6 of this second embodiment, the disk substrate and the stamper are formed with the central holes, these holes are not essential in this second embodiment, and these holes may be eliminated.

(Third Embodiment)

The third embodiment of the disk substrate imprinting method of the present invention utilizing the third example of the position adjusting member mentioned above will be described.

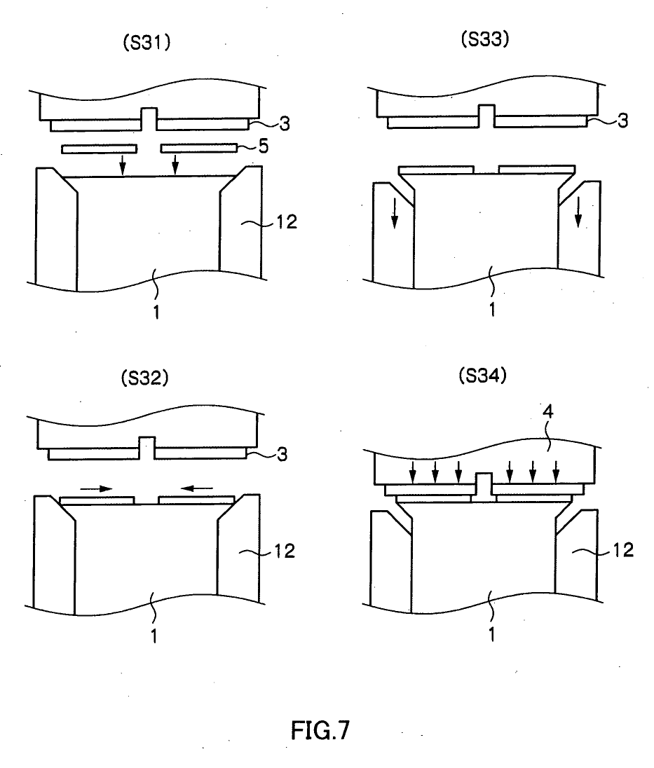

This third embodiment is concerned with the relative position adjustment between the disk substrate and the stamper of the first embodying mode, the method of this third embodiment includes the steps of S31 to S34 represented by FIG. 7.

As mentioned above, the characteristic features of this third embodiment resides in the adoption of the position adjusting member of the third example and the first embodying mode of the adjusting method.

With reference to FIG. 7, the illustrated states of the steps S31 to S34 are shown as the sectional view taken along the line II-II of FIG. 3C and correspond respectively to the steps S7 to S10 of the first embodiment of FIG. 5. In the first step S31 of the imprinting method of this third embodiment, the disk substrate 5 is mounted on the mount table 1. In the next step S32, the central position of the disk substrate 5 is adjusted and then fixed by using the support cylinder or cylindrical structure 12. The support cylinder 12 is then lowered (step S33), and the stamper 3 is thereafter lowered to thereby carry out the nano-imprinting operation (step S34).

The imprinting steps of the third embodiment is substantially identical to those of the first embodiment mentioned above in their basic principal except that there is utilized the support cylinder 12, which has polygonal (more than triangle) or circular, in cross section, inner hollow structure and has the taper portion 9 at its inner peripheral end portion. Accordingly, test imprinting operation and relative positional adjustment between the stamper and the disk substrate are substantially the same as those in the first embodiment.

In the imprinting method of the third embodiment mentioned above, in the disk substrate exchanging time after this positional adjustment, the positional adjustment between the central position of the fine pattern formed to the stamper and the central position of the disk substrate can be performed within the allowable range only by mounting the disk substrate on the mount table so that the outer peripheral portion of the disk substrate is supported by the taper portion 9 of the tapered surface of the support cylinder 12, thus being convenient and advantageous. Further, although, in the illustration of FIG. 7 of this third embodiment, the disk substrate and the stamper are formed with the central holes, these holes are not essential in this third embodiment, and these holes may be eliminated.

(Fourth Embodiment)

The fourth embodiment of the disk substrate imprinting method of the present invention utilizing the position adjusting member of the first example mentioned above will be described.

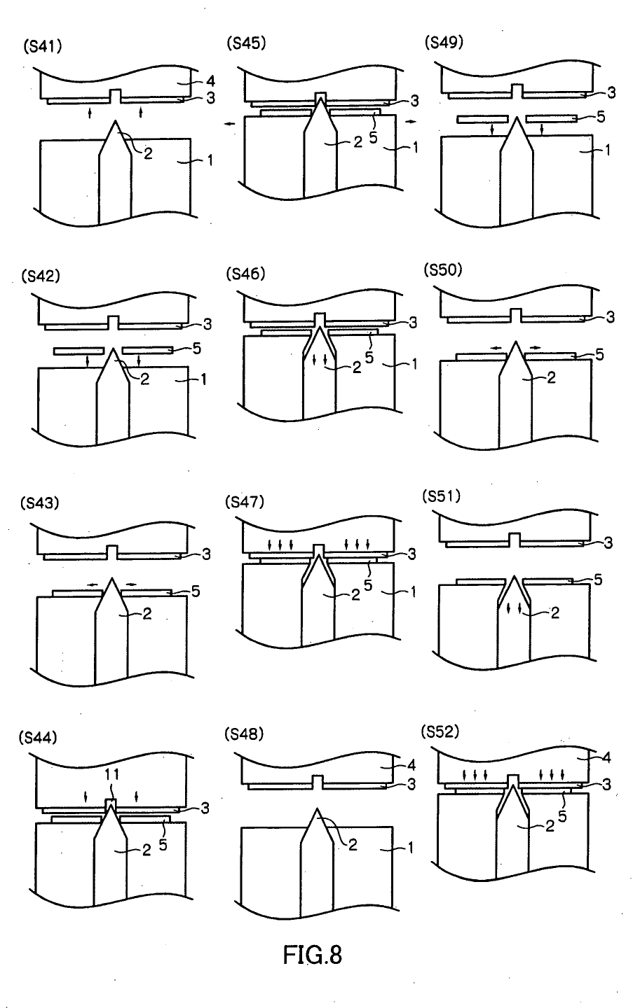

This fourth embodiment is concerned with the relative positional adjustment between the disk substrate and the stamper of the second embodying mode, the method of this fourth embodiment includes the steps of S41 to S52 represented by FIG. 8.

As mentioned above, the characteristic features of this fourth embodiment resides in the adoption of the position adjusting member of the first example and the second embodying mode of the adjusting method.

With reference to FIG. 8, the steps S41 to S43 correspond respectively to the steps S1 to S3 of the first embodiment. That is, the stamper 3 is mounted to the stamper mount table 4 (step S41), the disk substrate 5 to which the shape transfer layer is formed is then mounted on the disk substrate mount table 1 (step S42), and at this step, the center hole 6 of the disk substrate 5 is supported by the taper portion of the tapered surface of the taper pin 2 and, in this state, the disk substrate 5 is fixed on the mount table 1 (step S43).

Next, the stamper 3 is lowered with the taper pin being maintained as it is (step S44), and the mount table 1, on which the disk substrate 5 is mounted, is moved in the direction (X-Y axis direction) perpendicular to the moving direction of the taper pin 2 to thereby adjust the relative position between the stamper 3 and the disk substrate 5 (step S45). In the state of the step S44 of these steps, a small gap exists between the stamper 3 and the disk substrate 5, and in the state of not contacting to each other, the taper pin 2, which is utilized for positioning the disk substrate 5, also abuts against the inner peripheral surface of the central hole of the stamper 3. Therefore, the same one taper pin 2 can be utilized for performing the positional adjustment of both the disk substrate 5 and stamper 3, thus being effectively advantageous.

In the subsequent steps, the taper pin 2 is further lowered in the next step S46, and thereafter, the stamper 3 is also lowered (step S47), thus performing the imprinting operation. In this lowering distance (or speed) in the step S46 is determined so as not to abut against the stamper 3 which is thereafter lowered. The stamper 3 is then lowered to carry out the imprinting operation of the step S47 at a pressure of 32 kgf/cm² (=3.1 MPa) and temperature of 140° C. According to this imprinting step, the stamper 3 is lifted up (moved upward) so as to separate the stamper 3 from the disk substrate 5, and the disk substrate 5 is then removed from the mount table 1 (step S48).

According to this imprinting method of the fourth embodiment, the relative positional adjustment between the disk substrate 5 and the stamper 3 can be performed without carrying out any test imprinting operation, so that the mounting of the disk substrate 5 and the shaping thereof by the stamper 3 can be extremely effectively performed in the following steps of S49 to S52. Moreover, according to the imprinting method of this embodiment, the positional adjustment or alignment between the disk substrate 5 and the stamper 3 can be performed by the taper pin 2 through only one operation, i.e., without repeating the operation, thus being extremely effective and advantageous.

(Fifth Embodiment)

The fifth embodiment of the disk substrate imprinting method of the present invention utilizing the position adjusting member of the second example mentioned above will be described.

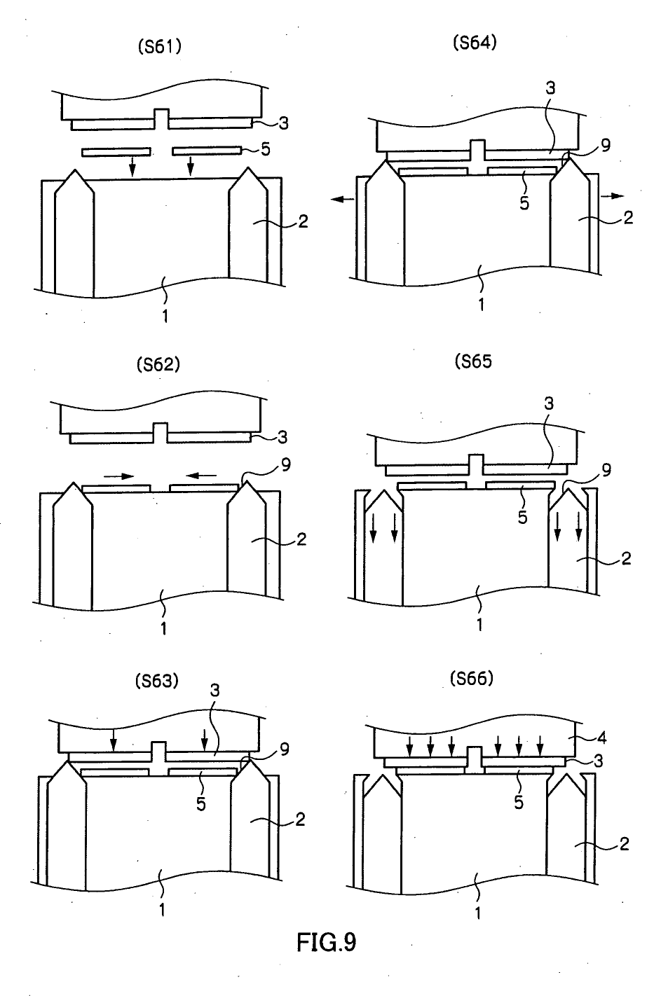

This fifth embodiment is concerned with the relative positional adjustment between the disk substrate and the stamper of the second embodying mode, the method of this fifth embodiment includes the steps of S61 to S66 represented by FIG. 9.

As mentioned above, the characteristic features of this fifth embodiment resides in the adoption of the position adjusting member of the second example and the second embodying mode of the adjusting method.

With reference to FIG. 9, the illustrated states of the steps S61 to S66 are shown as the sectional view taken along the line I-I of FIG. 3A and correspond respectively to the steps S42 to S47 of the fourth embodiment of FIG. 8. In the first step S61 of the imprinting method of this fifth embodiment, the disk substrate 5 is mounted on the mount table 1. In the next step S62, the central position of the disk substrate 5 is adjusted and then fixed by using three taper pins 2. The stamper 3 is thereafter lowered with the taper pins 2 being maintained as they are (step S63), and in the next step S64, the mount table 1 of the disk substrate 5 is moved in the direction (X-Y axis direction) perpendicular to the moving direction of the taper pins 2 to thereby adjust the relative position between the stamper 3 and the disk substrate 5. In the state of the step S64 of these steps, a small gap exists between the stamper 3 and the disk substrate 5, and in the state of not contacting to each other, the taper portions of the three taper pins 2 abut against the outer peripheral portion of the stamper 3. Therefore, the same taper pins 2 can be utilized for performing the positional adjustment of both the disk substrate 5 and stamper 3, thus being effectively advantageous.

In the subsequent steps, the three taper pins 2 are further lowered (step S65), and the stamper 3 is thereafter lowered, thus performing the imprinting operation (step S66). In the subsequent process, for example, the imprinting operation as like as that in the steps S48 to S52 of FIG. 8 will be repeated.

The imprinting steps of this fifth embodiment is substantially identical to those of the fourth embodiment mentioned above in their basic principal except that the three taper pins 2 are utilized as position adjusting member. However, in this fifth embodiment, since both the disk substrate 5 and stamper 3 are simultaneously adjusted in their positions at their outer peripheral portions by the taper portions of the three taper pins 2, the stamper 3 is formed so as to have a structure slightly (one size, for example) larger than the disk substrate.

In the imprinting method of the fifth embodiment mentioned above, the relative position between the disk substrate 5 and the stamper 3 is adjusted preliminarily by the three taper pins 2, so that, in the disk substrate exchanging time after this positional adjustment, the positional adjustment between the central position of the fine pattern formed to the stamper and the central position of the disk substrate can be performed within the allowable range only by mounting the disk substrate on the mount table so that the outer peripheral portion of the disk substrate 5 is supported by the three taper pins 2 at their taper portions, thus being convenient and advantageous. Further, although, in the illustration of FIG. 9 of this fifth embodiment, the disk substrate and the stamper are formed with the central holes, these holes are not essential in this fifth embodiment, and these holes may be eliminated.

(Sixth Embodiment)

The sixth embodiment of the disk substrate imprinting method of the present invention utilizing the third example of the position adjusting member mentioned above will be described.

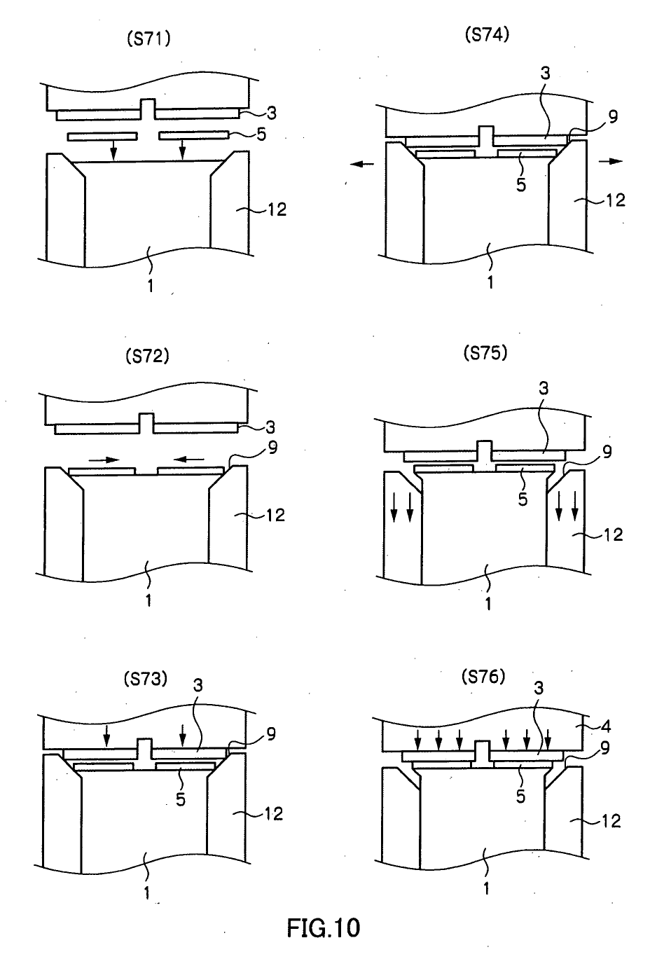

This sixth embodiment is concerned with the relative positional adjustment between the disk substrate and the stamper of the second embodying mode, the method of this sixth embodiment includes the steps of S71 to S76 represented by FIG. 10.

As mentioned above, the characteristic features of this sixth embodiment resides in the adoption of the position adjusting member of the third example and the second embodying mode of the adjusting method.

With reference to FIG. 10, the illustrated states of the steps S71 to S76 are shown as the sectional view taken along the line II-II of FIG. 3C and correspond respectively to the steps S42 to S47 of the fourth embodiment of FIG. 8. In the first step S71 of the imprinting method of this sixth embodiment, the disk substrate 5 is mounted on the mount table 1. In the next step S72, the central position of the disk substrate 5 is adjusted and then fixed by using the support cylinder 12. The stamper 3 is thereafter lowered with the support cylinder 12 being maintained as it is (step S73), and in the next step S74, the mount table 1 of the disk substrate 5 is moved in the direction (X-Y axis direction) perpendicular to the moving direction of the support cylinder 12 to thereby adjust the relative position between the stamper 3 and the disk substrate 5. In the state of the step S74 of these steps, a small gap exists between the stamper 3 and the disk substrate 5, and in the state of not contacting to each other, the taper portion 9 of the support cylinder 12 abuts against the outer peripheral portion of the stamper 3. Therefore, the relative positional adjustment of both the disk substrate 5 and stamper 3 can be performed by the same support cylinder 12, thus being effectively advantageous.

In the subsequent steps, the support cylinder 12 is further lowered (step S75), and the stamper 3 is thereafter lowered, thus performing the imprinting operation (step S76). In the subsequent process, for example, the imprinting operation as like as that in the steps S48 to S52 of FIG. 8 will be repeated.

The imprinting steps of this sixth embodiment is substantially identical to those of the fourth embodiment mentioned above in their basic principal except that the support cylinder 12 is used as position adjusting member. However, in this sixth embodiment, since both the disk substrate 5 and stamper 3 are simultaneously adjusted in their positions at their outer peripheral portions by the taper portion 9 of the support cylinder 12, the stamper 3 is formed so as to have a structure slightly (one size, for example) larger than the disk substrate 5.

In the imprinting method of the sixth embodiment mentioned above, the relative position between the disk substrate 5 and the stamper 3 is preliminarily adjusted by the support cylinder 12, so that, in the disk substrate exchanging time after this positional adjustment, the positional adjustment between the central position of the fine pattern formed to the stamper and the central position of the disk substrate can be performed within the allowable range only by mounting the disk substrate on the mount table so that the outer peripheral portion of the disk substrate 5 is supported by the support cylinder 12 at its taper portion, thus being convenient and advantageous. Further, although, in the illustration of FIG. 10 of this sixth embodiment, the disk substrate and the stamper are formed with the central holes, these holes are not essential in this sixth embodiment, and these holes may be eliminated.

It is further to be noted that the present invention is not limited to the described embodiments and many other changes and modifications may be made without departing from the scopes of the appended claims.

1. A method of imprinting a disk substrate comprising the steps of:
preparing a disk substrate formed with a shape transfer layer;
adjusting a position of the disk substrate in a state of supporting the disk substrate by a support portion formed to a position adjusting member disposed to be vertically movable with respect to the disk substrate;
preparing a stamper so as to be disposed in a state that a relative positional adjustment between the stamper and the position adjusted disk substrate is preliminarily made; and
shaping a pattern to the shape transfer layer of the disk substrate by using the stamper.

2. A disk substrate imprinting method according to claim 1, wherein the disk substrate has a center hole and the position adjusting member comprises a single taper pin having a taper portion and the taper pin contacts the center hole of the disk substrate at at least three points of the taper portion of the taper pin so as to support the disk substrate when the taper pin is fitted to the center hole of the disk substrate.

3. A disk substrate imprinting method according to claim 1, wherein the disk substrate has a center hole and the position adjusting member comprises at least two taper pins each having a taper portion, and the taper pins contact the center hole of the disk substrate at at least three points of the taper portions of the taper pins so as to support the disk substrate when the taper pins are fitted to the center hole of the disk substrate.

4. A disk substrate imprinting method according to claim 1, wherein the position adjusting member comprises at least three taper pins each having a taper portion, and the taper pins contact an outer peripheral surface of the disk substrate at taper portions of the taper pins so as to support the disk substrate.

5. A disk substrate imprinting method according to claim 1, wherein the position adjusting member comprises a support cylinder having an inner hollow structure of polygonal shape more than triangular shape and the support cylinder contacts an outer peripheral surface of the disk substrate at at least three inner taper portions of the support cylinder so as to support the disk substrate.

6. A disk substrate imprinting method according to claim 1, wherein the position adjusting member comprises a support cylinder having an inner hollow structure of circular shape and the support cylinder contacts an outer peripheral surface of the disk substrate at an inner taper portion of the support cylinder so as to support the disk substrate.

7. A disk substrate imprinting method according to claim 1, wherein the relative positional adjustment between the disk substrate and the stamper includes: a test imprinting step in which, after the disk substrate is supported at the taper portion of the position adjusting member and adjusted in the position thereof by the position adjusting member, the pattern is shaped to the shape transfer layer of the disk substrate by using the stamper; a position adjusting step in which an amount of eccentric distance of the shaped pattern is measured and the relative position between the disk substrate and the stamper is adjusted in accordance with the measured amount of eccentric distance; and a repeating step in which the test imprinting step and the position adjusting step are repeated till the measured amount of eccentric distance becomes less than a preliminarily set eccentric distance.

8. A disk substrate imprinting method according to claim 1, wherein the stamper has a center hole and the relative positional adjustment between the disk substrate and the stamper is performed by abutting the taper portion of the position adjusting member against the center hole, of the stamper.

9. A disk substrate imprinting method according to claim 1, wherein the relative positional adjustment between the disk substrate and the stamper is performed by abutting the taper portion of the position adjusting member against an outer peripheral portion of the stamper.

10. A disk substrate imprinting method according to claim 1, wherein the relative positional adjustment between the disk substrate and the stamper is performed by moving the disk substrate or the stamper in a direction perpendicular to the moving direction of the position adjusting member.

11. A method of manufacturing a disk-shaped recording medium characterized by comprising the disk substrate imprinting method according to claim 1.

12. An apparatus for imprinting a disk substrate comprising:
a mount table on which a disk substrate, to which a shape transfer layer is formed, is mounted;
a position adjusting member having a taper portion and disposed to be vertically movable with respect to the mount table, the disk substrate being adjusted in the position thereof by being supported by the taper portion of the position adjusting member; and
a stamper disposed so as to oppose to the disk substrate in a state that a relative position between the stamper and the position adjusted disk substrate is preliminarily adjusted, the stamper being used to shape a pattern to the shape transfer layer of the disk substrate.

13. A disk substrate imprinting apparatus according to claim 12, wherein the disk substrate has a center hole and the position adjusting member comprises a single taper pin having a taper portion, and the taper pin contacts the center hole of the disk substrate at at least three points of the taper portion of the taper pin so as to support the disk substrate when the taper pin is fitted to the center hole of the disk substrate.

14. A disk substrate imprinting apparatus according to claim 12, wherein the disk substrate has a center hole and the position adjusting member comprises at least two taper pins each having a taper portion, and the taper pins contact the center hole of the disk substrate at at least three points of the taper portions of the taper pins so as to support the disk substrate when the taper pins are fitted to the center hole of the disk substrate.

15. A disk substrate imprinting apparatus according to claim 12, wherein the position adjusting member comprises at least three taper pins which are arranged along outer peripheral portion of the disk substrate at substantially equal interval and each of which has a taper portion, and the taper pins contact an outer peripheral surface of the disk substrate at taper portions of the taper pins so as to support the disk substrate.

16. A disk substrate imprinting apparatus according to claim 12, wherein the position adjusting member comprises a support cylinder having an inner hollow structure of polygonal shape more than triangular shape, and the support cylinder contacts an outer peripheral surface of the disk substrate at at least three inner taper portions of the support cylinder so as to support the disk substrate.

17. A disk substrate imprinting apparatus according to claim 12, wherein the position adjusting member comprises a support cylinder having an inner hollow structure of circular shape and, the support cylinder contacts an outer peripheral surface of the disk substrate at an inner taper portion of the support cylinder so as to support the disk substrate.

18. A disk substrate imprinting apparatus according to claim 12, wherein the stamper has a center hole, and further comprising a member for moving the position adjusting member vertically with respect to the mount table so as to abut the taper portion of the position adjusting member against the center hole of the stamper.

19. A disk substrate imprinting apparatus according to claim 12, further comprising a member for moving the position adjusting member vertically with respect to the mount table so as to abut the taper portion of the position adjusting member against the outer peripheral portion of the stamper.

20. A disk substrate imprinting apparatus according to claim 12, wherein either one of the mount table and the stamper is moved in a direction perpendicular to the moving direction of the position adjusting member.
